(19) United States
(12) Patent Application Publication
(10) Pub. No.: US 2024/0154248 A1
(43) Pub. Date: May 9, 2024

(54) LASER PATTERNED SEPARATOR

(71) Applicant: Rivian IP Holdings, LLC, Plymouth, MI (US)

(72) Inventors: Meiyu ZHAI, South San Francisco, CA (US); Ruidong YANG, Hockessin, DE (US); Christopher Surya KOMPELLA, Saratoga, CA (US)

(21) Appl. No.: 17/983,789

(22) Filed: Nov. 9, 2022

(51) Int. Cl. H01M 50/434; H01M 50/457; H01M 50/469

(52) U.S. Cl. CPC H01M 50/434; H01M 50/457; H01M 50/469; H01M 2220/20

(57) ABSTRACT

Provided are separators for a battery cell comprising a polymer layer having a laser-patterned surface and a ceramic layer. The separators can further include a base layer, and the layers of the separator are provided in the following order: base layer, ceramic layer, and polymer layer. The laser-etching of the polymer layer does not modify the other layers of the separator.

### INTRODUCTION

The present disclosure generally relates to battery cells, and more particularly, to separators for battery cells comprising a ceramic polymer layer and a polymer layer comprising a laser-patterned surface.

### SUMMARY

Provided herein are separators for battery cells comprising a laser-patterned polymeric layer (i.e., a laser-patterned separator). Also provided are battery cells comprising a laser-patterned separator, rechargeable lithium-ion batteries comprising a laser-patterned separator, and electric vehicle systems comprising a laser-patterned separator. The laser-patterned separators described herein can minimize the heat effect zone and promote electrolyte flow in a battery cell comprising the laser-patterned separator.

In conventional polymer-coated separators, the polymer or adhesive layer (e.g., PVDF) is randomly distributed on a ceramic layer. This randomly-distributed polymer layer serves as an adhesive layer to increase the binding between an electrode of a battery cell and the separator. Thus, this irregular or random distribution may cause poor and/or uneven adhesion forces and can also cause uneven electrode wetting in the downstream battery production process.

Accordingly, the laser-patterned separators described herein utilize an ultra-fast or pulse laser to scan the surface of the randomly-distributed polymer layer to generate a pattern or design into the polymer layer. This laser surface treatment only modifies the upper polymer layer, and does not modify any underlying layers of the separator. Having the flexibility to generate different patterns on the polymer layer can improve the battery assembly process and cell performance. The optimized laser-patterned patterns can also have positive impacts on improving the battery mechanical integrity of ajelly roll battery, promoting electrolyte filling efficiency, reducing the cell resistance, forming a high quality solid electrolyte interphase layer, and improving the battery cyclability. Laser-etching separators as described herein is also an eco-friendly technology, since it does not require the application of additional chemicals.

In some embodiments, the laser-patterned separators described herein include a polymer layer deposited over a ceramic layer. The polymer layer is deposited onto the ceramic layer in a random or irregular manner. A pulse laser is used to etch a desired pattern into the polymer layer, without modifying the underling ceramic layer. In some embodiments, the polymer layer comprises polyvinylidene fluoride.

In some embodiments, a base layer is positioned underneath the ceramic layer, such that the separator comprises the following layers in order: base layer-ceramic layer-polymer layer. In some embodiments, the base layer comprises a polymer that is different from the polymer of the polymer layer.

In some embodiments, provided is a separator for a battery cell comprising: a polymer layer having a laser-patterned surface; and a ceramic layer.

In some embodiments of the separator, the polymer layer comprises one or more of a fluoropolymer, polyvinylidene fluoride, poly(methyl methacrylate), or polyvinylidene fluoride-hexafluoropropene copolymer.

In some embodiments of the separator, the ceramic layer comprises alumina.

In some embodiments of the separator, the polymer layer overlies the ceramic layer and only partially coats the ceramic layer.

In some embodiments of the separator, the separator comprises a base layer.

In some embodiments of the separator, the ceramic layer overlies the base layer.

In some embodiments of the separator, a pattern of the laser-patterned surface of the separator is formed only on the polymer layer.

In some embodiments of the separator, a pattern of the laser-patterned surface of the separator is not formed on the base layer or the ceramic layer.

In some embodiments of the separator, the laser-patterned surface is formed using a pulse laser.

In some embodiments of the separator, a pattern of the laser-patterned surface comprises a plurality of parallel lines.

In some embodiments of the separator, a depth of each parallel line of the plurality of parallel lines is 2-3 μm and a width of each parallel line of the plurality of parallel lines is 5 μm to 0.2 mm.

In some embodiments of the separator, a pattern of the laser-patterned surface comprises a plurality of dots.

In some embodiments of the separator, each dot of the plurality of dots has a radius of 5 μm to 0.2 mm, and a depth of each parallel line of the plurality of parallel lines is 2-3 μm.

In some embodiments of the separator, a pattern of the laser-patterned surface comprises a spiral pattern.

In some embodiments of the separator, the spiral pattern comprises a spiral line having a width of 5 μm to 0.2 mm and a depth of 2-3 μm.

In some embodiments, provided is a rechargeable lithium-ion battery comprising: a separator for a battery cell comprising: a polymer layer having a laser-patterned surface; and a ceramic layer.

In some embodiments, provided is an electric vehicle system comprising a rechargeable lithium-ion battery comprising a separator for a battery cell comprising: a polymer layer having a laser-patterned surface; and a ceramic layer.

The embodiments disclosed above are only examples, and the scope of this disclosure is not limited to them. Particular embodiments may include all, some, or none of the components, elements, features, functions, operations, or steps of the embodiments disclosed above. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE FIGURES

FIG. 1A provides a depiction of a ceramic coated separator;

FIG. 1B provides a depiction of a hybrid separator;

FIG. 1C provides a depiction of a ceramic and adhesive layer coated separator;

FIG. 2 shows a process for laser-etching a polymer layer of a separator, according to some embodiments;

FIG. 3A shows a line-patterned pattern, according to some embodiments;

FIG. 3B shows a dot-patterned pattern, according to some embodiments;

FIG. 3C shows a spiral-patterned pattern, according to some embodiments;

FIG. 4A provides a depiction of a separator having no adhesive layer and its effect on the electrolyte filling process;

FIG. 4B provides a depiction of a separator having a fully-covered porous layer and its effect on the electrolyte filling process;

FIG. 4C provides a depiction of a separator having an island-coated polymer layer and its effect on the electrolyte filling process;

FIG. 4D provides a depiction of a separator having a laser-patterned polymer layer and its effect on the electrolyte filling process, according to some embodiments;

FIG. 5 shows a microscopic image of a polymer layer of a separator with no laser etching;

FIG. 6 shows an untreated surface of an island-coated PVDF separator (left), and a treated surface of an island-coated PVDF separator (right), according to some embodiments;

FIG. 7A shows a water droplet on an untreated separator, according to some embodiments;

FIG. 7B shows a water droplet on a laser treated separator, according to some embodiments;

FIG. 8 illustrates a flow chart for a typical battery cell manufacturing process, according to some embodiments;

FIG. 9 depicts an illustrative example of a cross sectional view of a cylindrical battery cell, according to some embodiments;

FIG. 10 depicts an illustrative example of a cross sectional view of a prismatic battery cell, according to some embodiments;

FIG. 11 depicts an illustrative example of a cross section view of a pouch battery cell, according to some embodiments;

FIG. 12 illustrates cylindrical battery cells being inserted into a frame to form a battery module and pack, according to some embodiments;

FIG. 13 illustrates prismatic battery cells being inserted into a frame to form a battery module and pack, according to some embodiments;

FIG. 14 illustrates pouch battery cells being inserted into a frame to form a battery module and pack, according to some embodiments; and

FIG. 15 illustrates an example of a cross sectional view of an electric vehicle that includes at least one battery pack, according to some embodiments.

In the Figures, like reference numerals refer to like components unless otherwise stated herein.

### DETAILED DESCRIPTION

Provided herein are separators for battery cells comprising a polymer layer and a ceramic layer, wherein the polymer layer overlies, or is deposited onto, the ceramic layer. The polymer layer comprises a laser-patterned design, which can help minimize the heat effect zone and promote electrolyte flow in a battery cell comprising the laser-patterned separator Also provided are battery cells comprising a laser-patterned separator, rechargeable lithium-ion batteries comprising a laser-patterned separator, and electric vehicle systems comprising a laser-patterned separator. In some embodiments, the polymer layer comprises polyvinylidene fluoride. In some embodiments, the ceramic layer comprises alumina. In some embodiments, the separator further includes a base layer located opposite the ceramic layer relative to the polymer layer.

As described above, conventional polymer-coated separators, for example, polyvinylidene fluoride (PVDF)-coated separators, include a randomly-distributed polymer layer (e.g., PVDF) on a ceramic layer. This randomly-distributed polymer layer serves as an adhesive layer to increase the binding between an electrode of a battery cell and the separator. However, this irregular or random distribution may cause poor and/or uneven adhesion forces and can also cause uneven electrode wetting in the downstream battery prototyping process.

Conversely, the laser-patterned separators described herein comprise an patterned pattern in the polymer layer. The etching pattern does not modify any of the other layers of the separator (e.g., ceramic layer, base layer). However, by modifying the polymer layer with a pulse laser, the laser-patterned separator can improve the battery assembly process and cell performance. The optimized laser-patterned patterns can also have positive impacts on improving the battery mechanical integrity of a jelly roll battery, promoting electrolyte filling efficiency, reducing the cell resistance, forming a high quality solid electrolyte interphase layer, and improving the battery cyclability.

### Coated Separators

Described below are various types of coated separators. The coated separators described in this section do not include a laser-patterned pattern, but instead illustrate some of the challenges that can be overcome with a laser-patterned polymer layer.

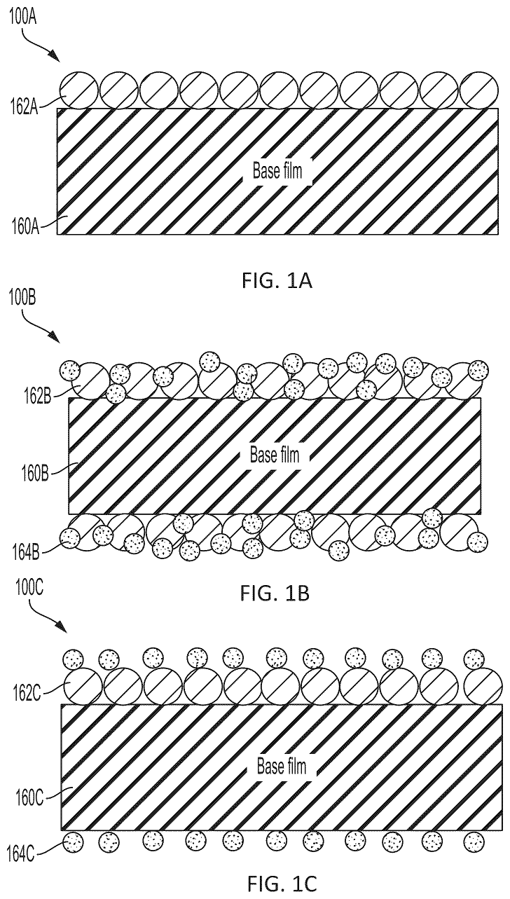

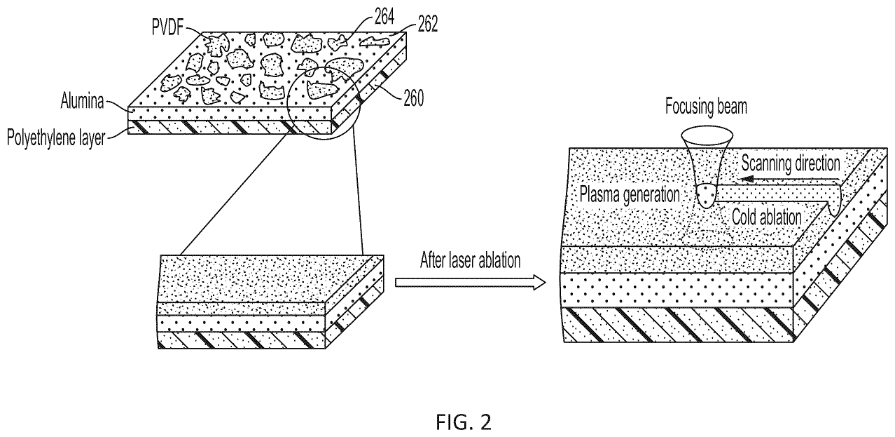

FIG. 1A shows a depiction of a ceramic coated separator 100A. Unlike the separators described herein, this separator only includes a base film 160A (analogous to the base layer of the separators described herein) and a ceramic coating 162A. A ceramic coated separator, such as the one depicted in FIG. 1A, can exhibit higher mechanical strength, lower heat shrinkage, better electrolyte wettability, and no or poor adhesion with electrodes. Thus, a separator with only a ceramic coating, such as that shown in FIG. 1A, does not provide adequate adhesion to electrodes. This concept is further shown in FIG. 2, discussed below.

FIG. 1B shows a depiction of a hybrid separator 100B that includes a composite layer comprising polymer particles 164B and ceramic particles 162B coated on opposing layers of base film 160B. When treated with a laser as described herein, the laser only modifies the polymer particles 164B. However, any ceramic particles 162B attached to the base film 160B by way of the polymer particles 164B would also be removed from the separator during laser treatment.

FIG. 1C shows a depiction of a ceramic coated separator 100C that also includes an polymer layer or adhesive coating. Specifically, the ceramic coating 162C is layered over the base film 160C (analogous to the base layer of the separators described herein). The adhesive coating (polymer layer) 164C is coated on two opposing sides of the ceramic coated separator, on both the base film 160C and the ceramic coating 162C. A ceramic coated separator further comprising an adhesive coating (polymer layer), such as the separator depicted in FIG. 1C, can exhibit improved adhesion with electrodes, lower heat shrinkage due to adhesion with electrodes, and more integrated jelly roll and/or electrode stack. However, this embodiment does not allow for sufficient wetting optimization. Particularly, low electrode stack permeability (or low wettability/high wetting times) can cause long fill times.

During a laminating stacking process, a separator without an adhesion layer can cause peeling, separation, wrinkling, and displacement. However, a separator with an adhesion layer can form a rigid, easy to handle pouch cell without the drawbacks described immediately above with regards to a separator without the adhesion layer. Thus, a polymer-coated separator is preferable to a ceramic-only coated separator. However, as demonstrated below, a polymer-coated separator without further modification (i.e., laser ablation) does not achieve optimal electrolyte wetting.

Literature data (e.g., “Effects of Island-Coated PVdF-HFP Composite Separator on the Performance of Commercial Lithium-ion Batteries” Coatings (2018) 8, 437: 1-9), teaches that the resistance of a polyethylene (PE) separator has a much higher resistance and a much lower discharge capacity than porous-coated and/or island-coated separators. Thus, the separators that include the adhesion/polymer layer (i.e., the porous-coated separator and the island-coated separator) exhibit betterjelly roll integrity and better cyclability. Further, the deposition pattern, quantity, and distribution of the first polymer adhesive layer affects battery cycling performance due to its impact on cell resistance and electrolyte wetting. The base film may be a solid, porous film, such as thermoplastic material (e.g., polyethylene, polypropylene, polystyrene, polyvinyl chloride, aramid or nylon), cellulose, glass fiber, or pressed particles films, like alumina or zirconia. The base film can be coated with one or more types of coatings. The coating includes inorganic coatings, such as alumina, boehmite, SiO₂, ZrO₂, zeolite and some organic coatings such as Aramid. The coating also include polymers with adhesive functions, such as PVDF, PMMA, PVA, PAA, PVDF-HPF, PEO, CMC and SBR

The thickness of each type of separator can also inform which type of separator may be suitable for laser treatment. Specifically, the thickness of island-coated pouch cells is the lowest (compared to PE and porous-coated separators) after 600 cycles. (See “Effects of Island-Coated PVdF-HFP Composite Separator on the Performance of Commercial Lithium-ion Batteries” Coatings (2018) 8, 437: 1-9.) As the cell cycles, it typically swells, which hurts the cell performance. Cells with less swelling (e.g., island-coated separators) indicate better “health” and suggest the adhesion of the electrodes to separator is better and/or less impacted over the life of the cell. Thus, the Figure shows that cells having island-coated separators tend to experience less swelling, and therefore increased “health” as compared to PE separators and/or porous-coated separators.

### Laser-Patterned Separators

Described below are laser-patterned separators, according to embodiments described herein. In some embodiments, the polymer layer may comprise polyvinylidene fluoride. The laser etching modifies only the polymer layer, and not the ceramic layer or the base layer by melting or ablating off material at a certain depth and minimum heat affected area.

Laser etching or ablation includes removing microscopic layers of material. Laser treatment or modification, as used herein, includes melting or minimal penetration to a certain depth. The embodiments herein include laser treatment or laser modification.

FIG. 2 shows a process for laser-treating a polymer layer of a separator, according to some embodiments. As shown, the separator includes a ceramic layer 262 overlying a base layer 260, and a polymer layer 264 overlying the ceramic layer 262. The polymer layer 264 is deposited onto the ceramic layer 262. In some embodiments, the polymer layer may comprise one or more of a fluoropolymer, polyvinylidene fluoride, polyvinyl alcohol, polyacrylic acid, poly(methyl methacrylate) (e.g., Troysol™ AFL), or polyvinylidene fluoride-hexafluoropropene copolymer. In some embodiments, the ceramic layer may be formed of particulates. In some embodiments, the ceramic layer may comprise a ceramic particle layer or a ceramic coating. In some embodiments, the ceramic layer may comprise one or more of alumina, boehmite, silicon dioxide, zirconium dioxide, or zeolites. In some embodiments, the base layer may comprise a polymer layer. In some embodiments, the base layer may comprise one or more of a polyolefin (e.g., polyethylene, polypropylene), polyester, cellulose, glass fiber, polystyrene, cyclic olefin polymer/copolymer, polycarbonate, poly(methyl methacrylate) (acrylic), or ultraviolet acrylic.

After the layers of the separator are arranged, the separator can be treated with a laser treatment process using a pulse or ultra-fast laser. In some embodiments, the laser may be a 355 nm laser. In some embodiments, the laser may be a 1030 nm IR laser. However, the laser treatment process is selected to ensure that only the polymer layer 264 is modified, and not the ceramic layer 262 or the base layer 260.

Optical absorption spectra and optical transmission spectra of polyvinylidene fluoride and poly(methyl methacrylate) demonstrate that both polyvinylidene fluoride and poly(methyl methacrylate) are suitable polymers for the polymer layer. However polyvinylidene fluoride (PVDF) has good absorption under 355 nm, specifically indicating that a polymer layer comprising PVDF can be modified using laser treatment process with a 355 nm pulse laser.

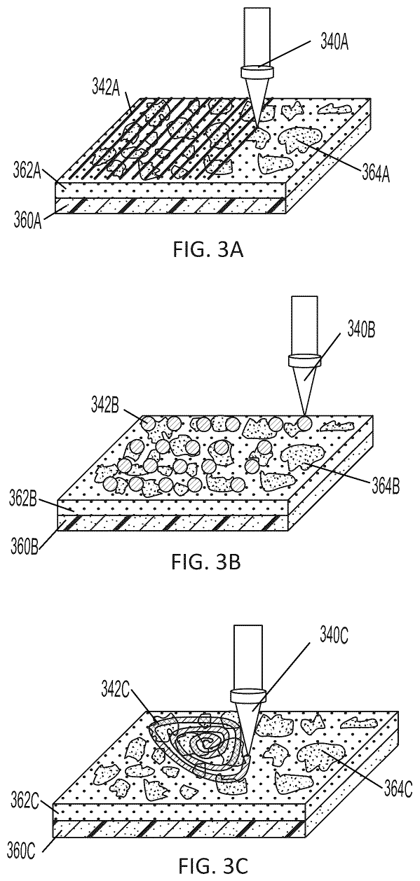

FIGS. 3A-3C show various laser-patterned patterns, according to some embodiments. The patterns shown in FIGS. 3A-3C are not meant to be exhaustive, but only exemplary in nature.

FIG. 3A shows a laser-patterned pattern comprising a laser pattern 342A in the form of a plurality of lines extending from a first side of the separator to an opposing side of the separator. The laser pattern 342A is formed by laser 340A and modifies only the top polymer layer 364A (shown as islands). The laser pattern 342A does not modify the ceramic layer 362A or the base layer 360A. The lines are parallel and equidistant. In some embodiments, the distance between two laser-patterned lines in a parallel line pattern may be 20-200 μm. In some embodiments, the distance between two laser-patterned lines may be less than or equal to 200, 150, 100, 50, or 30 μm. In some embodiments, the distance between two laser-patterned lines may be greater than or equal to 20, 30, 50, 100, or 150 μm. In some embodiments, the depth of a laser-patterned line may be 1-5 μm. In some embodiments, the depth of each line of laser pattern 342A may be less than 5, 4, 3, or 2 μm. In some embodiments, the depth of each line of laser pattern 342A may be greater than 1, 2, 3, or 4 μm. In some embodiments, a width of each laser-patterned line may be 5 μm to 2 mm. In some embodiments, a width of each line of laser pattern 342A may be less than or equal to 2 mm, 1 mm, 0.2 mm, 500 μm, 250 μm, 100 μm, 50 μm, 25 μm, 20 μm, 15 μm, or 10 μm. In some embodiments, a width of each line of laser pattern 342A may be greater than or equal to 5 μm, 10 μm, 15 μm, 20 μm, 25 μm, 50 μm, 100 μm, 250 μm, 500 μm, 0.2 mm, or 1 mm.

FIG. 3B shows a laser-patterned pattern comprising a laser pattern 342B in the form of a plurality of dots. The laser pattern 342B is formed by laser 340B and modifies only the top polymer layer 364B (shown as islands). The laser pattern 342B does not modify the ceramic layer 362B or the base layer 360B. The dots may be regularly spaced or irregularly spaced. The dots may be identical in size or irregular in size. In some embodiments, each dot of the laser pattern 342B has a radius of 5 μm to 2 mm. In some embodiments, each dot laser pattern 342B has a radius of less than or equal to 2 mm, 1 mm, 0.2 mm, 500 μm, 250 μm, 100 μm, 50 μm, 25 μm, 20 μm, 15 μm, or 10 μm. In some embodiments, each dot laser pattern 342B has a radius greater than or equal to 5 μm, 10 μm, 15 μm, 20 μm, 25 μm, 50 μm, 100 μm, 250 μm, 500 μm, 0.2 mm, or 1 mm. In some embodiments, each dot laser pattern 342B has a depth of 1-10 μm. In some embodiments, each dot laser pattern 342B has a depth of less than or equal to 10, 9, 8, 7, 6, 5, 4, 3, or 2 μm. In some embodiments, each dot laser pattern 342B has a depth of greater than or equal to 1, 2, 3, 4, 5, 6, 7, 8, or 9 μm.

FIG. 3C shows a laser-patterned pattern comprising a laser pattern 342C in the form of a spiral. The laser pattern 342C is formed by laser 340C and modifies only the top polymer layer 364C (shown as islands). The laser pattern 342C does not modify the ceramic layer 362C or the base layer 360C. The spiral pattern may be symmetrical, or it may be irregular. In some embodiments, the laser pattern 342C comprises a spiral line having a width of 5 μm to 2 mm. In some embodiments, the laser pattern 342C comprises a spiral line having a width of less than or equal to 2 mm, 1 mm, 0.2 mm. 500 μm, 250 μm, 100 μm, 50 μm, 25 μm, 20 μm, 15 μm, or 10 μm. In some embodiments, the laser pattern 342C comprises a spiral line having a width of greater than or equal to 5 μm, 10 μm, 15 μm, 20 μm, 25 μm, 50 μm, 100 μm, 250 μm, 500 μm, 0.2 mm, or 1 mm. In some embodiments, the laser pattern 342C comprises a spiral line having a depth of 1-10 μm. In some embodiments, the laser pattern 342C comprises a spiral line having a depth of less than or equal to 10, 9, 8, 7, 6, 5, 4, 3, or 2 μm. In some embodiments, the laser pattern 342C comprises a spiral line having a depth of greater than or equal to 1, 2, 3, 4, 5, 6, 7, 8, or 9 μm.

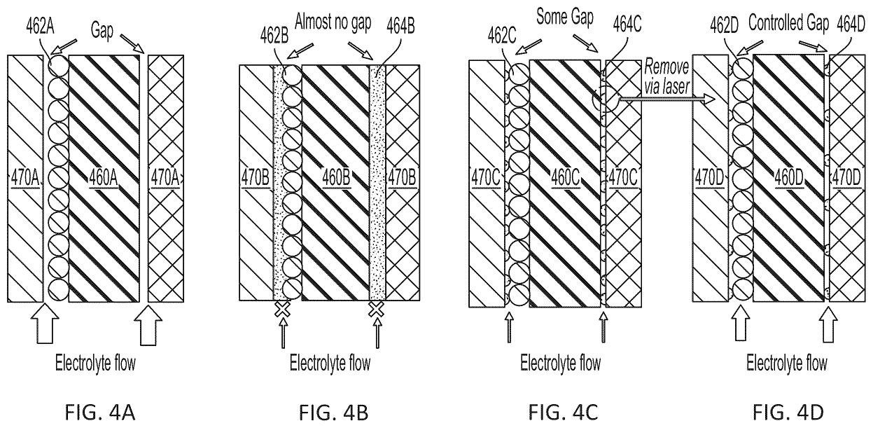

FIGS. 4A-4D provide side-view depictions of separators having various features between two electrodes. FIG. 4A shows a depiction of a ceramic-coated separator having no first polymer or adhesive layer. The separator comprises base layer 460A and ceramic layer 462A. As shown, there is a significant gap between the electrodes 470A and the separator, allowing for significant electrolyte flow between the separator and the electrodes.

FIG. 4B shows a depiction of a separator having a fully-covered porous-coated separator. This separator comprises base layer 460B, ceramic layer 462B, and first polymer or adhesive layer 464B. As shown, there is almost no gap between the separator and the electrodes 470B, allowing for no electrolyte flow between the separator and electrodes. The only electrolyte that can flow must do so through the pores of the polymer layer.

FIG. 4C shows a depiction of a separator having an island-coated separator. This separator includes base layer 460C, ceramic layer 462C, and first polymer or adhesive layer 464C. As shown, there is a controlled gap between the separator and electrodes 470C, allowing for some electrolyte flow between the separator and electrodes. This indicates that the electrolyte can reach the electrode surface for faster electrolyte filling.

FIG. 4D shows a depiction of a laser-patterned separator, according to some embodiments provided herein. This separator includes base layer 460D, ceramic layer 462D, and an patterned first polymer or adhesive layer 464D. As shown, there is a controlled gap between the separator and electrodes 470D, allowing for some electrolyte flow between the separator and electrodes. This indicates that the electrolyte can reach the electrode surface for faster electrolyte filling. However, unlike the island-coated separator of FIG. 4C, the patterned separator of FIG. 4D can optimize the wetting while still maintaining sufficient adhesive force.

### Methods of Producing Laser-Patterned Separators

Described herein are methods of producing laser-patterned separators.

In some embodiments, the layers of the separator are formed prior to etching. This can include depositing a ceramic layer on top of a base layer using a wet-coating method. A polymer layer is then deposited on top of the ceramic layer using either a wet-coating or a spray-coating technique. In some embodiments, electrospinning may be used to deposit the ceramic and/or polymer layers.

Once the layers of the separator are formed, the top polymer layer may be modified using a laser treatment process. In some embodiments, a 355 nm pulse laser may be used to form a pattern into the polymer layer of the separator.

### Examples

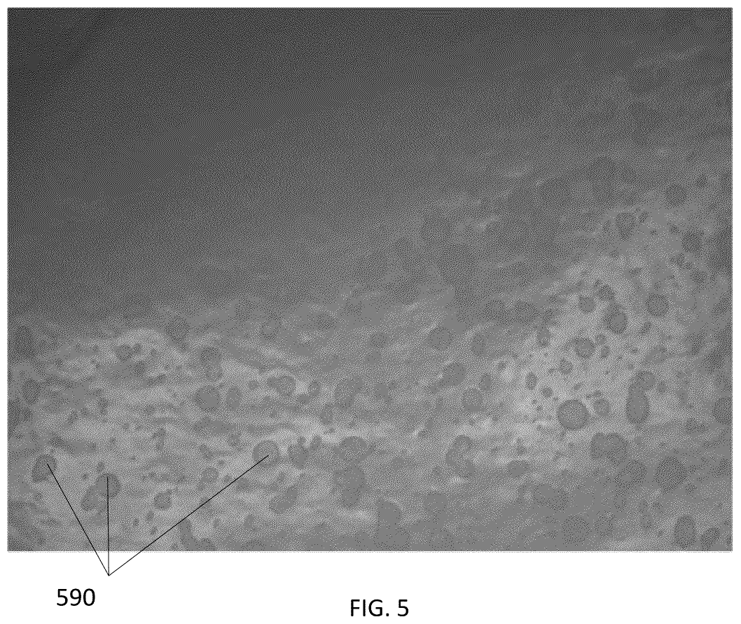

FIG. 5 shows a microscopic image of a polymer layer of a separator with no laser etching. Islands 590 show the various islands of the polymer layer deposited on top of the ceramic layer of the separator. As shown in the image, the distribution of the islands are random and non-uniform in shape and size.

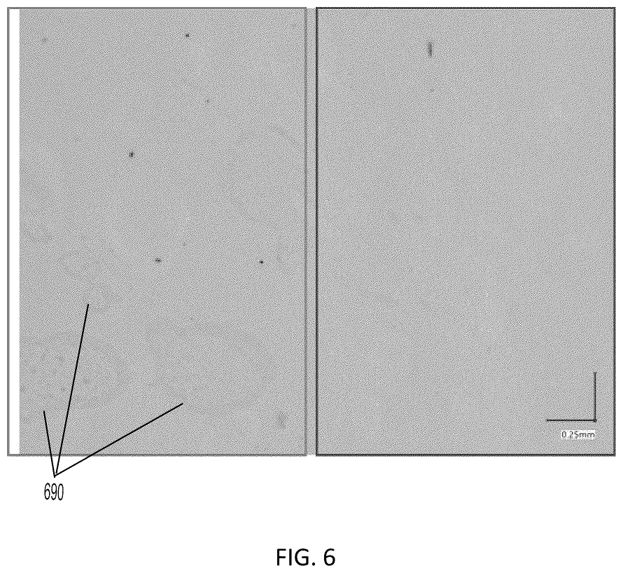

FIG. 6 shows a untreated surface (left) next to a treated surface (right). The untreated surface (left) shows the upper PVDF layer (islands 690). The upper PVDF layer of the right treated surface was lasered off. Thus, there is no PVDF island shown in this portion of the figure. Further, the material layer directly underneath the PVDF layer (e.g., ceramic layer) was not modified by the laser treatment.

Conversely, the untreated surface shows faint randomly-distributed PVDF islands that have not been laser-treated.

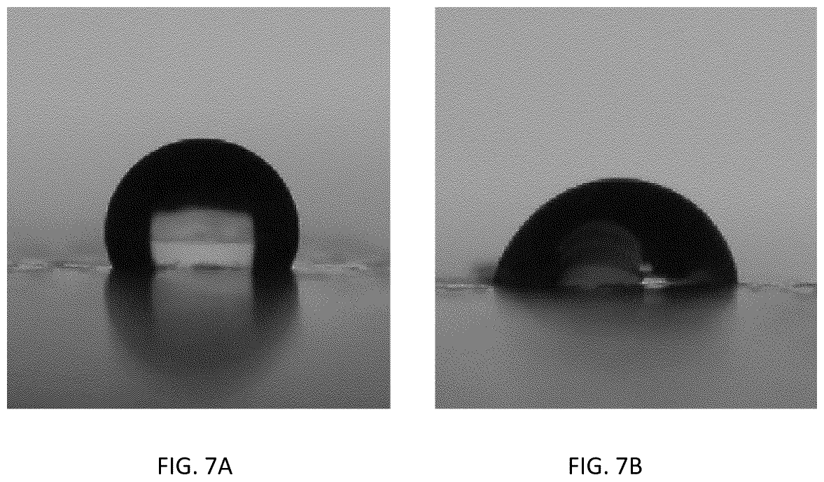

FIG. 7A shows a water droplet on an untreated surface of a separator, whereas FIG. 7B shows a water droplet on a laser-treated surface of a separator. The contact angle of the water droplet in 7A is approximately 115°, and the contact angle of the water droplet in 7B is approximately 72.9°. The specific contact angle of the laser-treated surface can be tuned from less than 10° to about 140°, depending on the laser parameters. The contact angle can be indicative of the wettability of the separator, where a lower contact angle can indicate improved wettability. The laser treatment describd can tune the surface wettability from hydrophobic to hydrophilic. The image we showed here indicating the low surface contact angle, but we could also do the opposite direction, which we would also like to cover in this ID.

### Battery Cells, Battery Modules, Battery Packs, and Electric Vehicle Systems

The laser-patterned separators described above can be used in the fabrication of battery cells, rechargeable metal-ion batteries (e.g., lithium, sodium, potassium, aluminum, magnesium), and electric vehicle systems. More specifically, the laser-patterned separators described herein may be used in the fabrication of battery cells that can be used to form battery modules, and/or battery packs. Battery cells, battery modules, and/or battery packs comprising a laser-patterned separator described herein may then be used as a power source in electric vehicles. These embodiments are described in detail below.

Reference will now be made to implementations and embodiments of various aspects and variations of battery cells, battery modules, battery packs, and the methods of making such battery cells, battery modules, and battery packs. Although several exemplary variations of the battery cells, modules, packs, and methods of making them are described herein, other variations of the battery cells, modules, packs and methods may include aspects of the battery cells, modules, packs and methods described herein combined in any suitable manner having combinations of all or some of the aspects described. In addition, any part of or any of the electrodes, densified electrodes, components, systems, methods, apparatuses, devices, compositions, etc. described herein can be implemented into the battery cells, battery modules, battery packs, and methods of making these battery cells, battery modules, and battery packs.

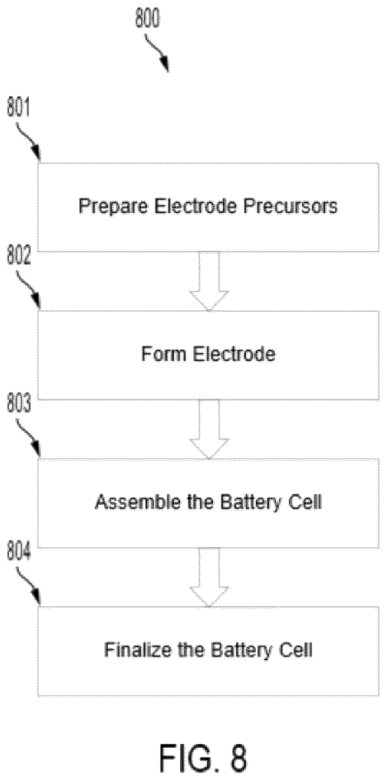

FIG. 8 illustrates a flow chart for a typical battery cell manufacturing process 800. These steps are not exhaustive and other battery cell manufacturing processes can include additional steps or only a subset of these steps. At step 801, the electrode precursors (e.g., binder, active material, conductive carbon additive) can be prepared. In some embodiments, this step can include mixing electrode materials (e.g., active materials) with additional components (e.g., binders, solvents, conductive additives, etc.) to form an electrode slurry. In some embodiment, this step can include synthesizing the electrode materials themselves.

At step 802, the electrode can be formed. In some embodiments, this step can include coating an electrode slurry on a current collector. In some embodiments, the electrode or electrode layer can include electrode active materials, conductive carbon material, binders, and/or other additives.

In some embodiments, the electrode active materials can include cathode active materials. In some embodiments, the cathode active materials can include olivine or phosphate-based cathode active materials. In some embodiments, the cathode active materials can include over-lithiated-oxide material (OLO), nickel-based cathode materials (e.g., nickel manganese cobalt (NMC) such as NMC111, NMC523, NMC622, NMC811, NMCA, nickel cobalt aluminum oxide (NCA), and Ni90+). In some embodiments, the cathode active materials can include high-nickel content (greater than or equal to about 80% Ni) lithium transition metal oxide. Such lithium transition metal oxides can include a particulate lithium nickel manganese cobalt oxide (“LiNMC”), lithium nickel cobalt aluminum oxide (“LiNCA”), lithium nickel manganese cobalt aluminum oxide (“LiNMCA”), lithium cobalt oxide (LCO), lithium manganese oxide (LMO), lithium metal phosphates like lithium iron phosphate (“LFP”), lithium iron manganese phosphate (“LMFP”), sulfur containing cathode materials, lithium sulfide (Li₂S), lithium polysulfides, titanium disulfide (TiS₂), and combinations thereof.

In some embodiments, the electrode active materials can include anode active materials. In some embodiments, the anode active materials can include graphitic carbon (e.g., ordered or disordered carbon with sp2 hybridization, artificial or natural Graphite, or blended), Li metal anode, silicon-based anode (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. In some embodiments, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell may not comprise an anode active material in an uncharged state.

In some embodiments, the conductive carbon material can include graphite, carbon black, carbon nanotubes, Super P carbon black material, Ketjen Black, Acetylene Black, SWCNT, MWCNT, carbon nanofiber, graphene, and combinations thereof.

In some embodiments, the binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

After coating, the coated current collector can be dried to evaporate any solvent. In some embodiments, this step can include calendaring the coated current collectors. Calendaring can adjust the physical properties (e.g., bonding, conductivity, density, porosity, etc.) of the electrodes. In some embodiments, the electrode can then be sized via a slitting and/or notching machine to cut the electrode into the proper size and/or shape.

In some embodiments, solid electrolyte materials of the solid electrolyte layer can include inorganic solid electrolyte materials such as oxides, sulfides, phosphides, halides, ceramics, solid polymer electrolyte materials, hybrid solid state electrolytes, or glassy electrolyte materials, among others, or in any combinations thereof. In some embodiments, the solid electrolyte layer can include a polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LixPOyNz), among others, or in any combinations thereof. In some embodiments, the solid electrolyte layer can include a glassy, ceramic and/or crystalline electrolyte material such as Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, lithium phosphorous oxy-nitride (LiₓPO_{y}N_{z}), lithium germanium phosphate sulfur (LiioGeP₂S₁₂), Yttria-stabilized Zirconia (YSZ), NASICON (Na₃Zr₂Si₂POi₂), beta-alumina solid electrolyte (BASE), perovskite ceramics (e.g., strontium titanate (SrTiO₃)), Lithium lanthanum zirconium oxide (La₃Li₇₀₁₂Zr₂), LiSiCON (Li2+2xZn1-xGeO4), lithium lanthanum titanate (Li3xLa2/3-xTiO3) and/or sulfide-based lithium argyrodites with formula Li₆PS₅X (X=Cl, Br) like Li₆PS₅Cl, among others, or in any combinations thereof. Furthermore, solid state polymer electrolyte materials can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), and PEG, among others, or in any combinations thereof.

At step 803, the battery cell can be assembled. After the electrodes, separators, and/or electrolytes have been prepared, a battery cell can be assembled/prepared. In this step, the separator and/or an electrolyte layer can be assembled between the anode and cathode layers to form the internal structure of a battery cell. These layers can be assembled by a winding method such as a round winding or prismatic/flat winding, a stacking method, or a z-folding method.

The assembled cell structure can then be inserted into a cell housing which is then partially or completed sealed. In addition, the assembled structure can be connected to terminals and/or cell tabs (via a welding process). For battery cells utilizing a liquid electrolyte, the housed cell with the electrode structure inside it can also be filled with electrolyte and subsequently sealed.

Battery cells can have a variety of form factors, shapes, or sizes. For example, battery cells (and their housings/casings) can have a cylindrical, rectangular, square, cubic, flat, or prismatic form factor, among others. There are four main types of battery cells: (1) button or coin cells; (2) cylindrical cells; (3) prismatic cells; and (4) pouch cells. Battery cells can be assembled, for example, by inserting a winding and/or stacked electrode roll (e.g., a jelly roll) into a battery cell casing or housing. In some embodiments, the winded or stacked electrode roll can include the electrolyte material. In some embodiments, the electrolyte material can be inserted in the battery casing or housing separate from the electrode roll. In some embodiments, the electrolyte material includes, but is not limited to, an ionically conductive fluid or other material (e.g., a layer) that can allow the flow of electrical charge (i.e., ion transportation) between the cathode and anode. In some embodiments, the electrolyte material can include a non-aqueous polar solvent (e.g., a carbonate such as ethylene carbonate, propylene carbonate, diethyl carbonate, ethyl methyl carbonate, dimethyl carbonate, or a mixture of any two or more thereof). The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. In addition, the salt may be present in the electrolyte from greater than 0 M to about 5 M, or for example salt may be present between about 0.05 to 2 M or about 0.1 to 2 M.

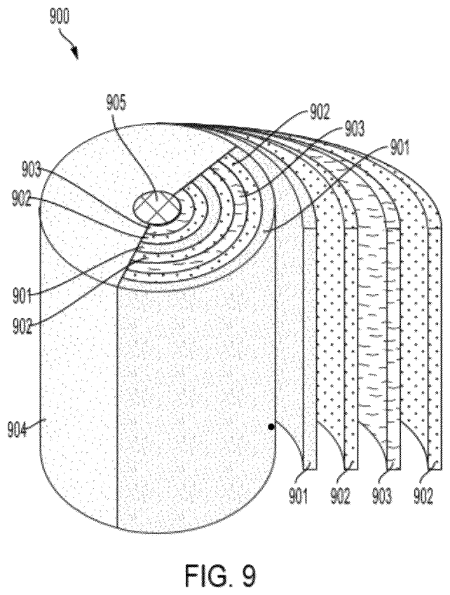

FIG. 9 depicts an illustrative example of a cross sectional view of a cylindrical battery cell 900. The cylindrical battery cell can include layers (e.g., sheet-like layers) of anode layers 901, separator and/or electrolyte layers 902, and cathode layers 903.

A battery cell can include at least one anode layer, which can be disposed within the cavity of the housing/casing. The battery cell can also include at least one cathode layer. The at least one cathode layer can also be disposed within the housing/casing. In some embodiments, when the battery cell is discharging (i.e., providing electric current), the at least one anode layer releases ions (e.g., lithium ions) to the at least one cathode layer generating a flow of electrons from one side to the other. Conversely, in some embodiments, when the battery cell is charging, the at least one cathode layer can release ions and the at least one anode layer can receive these ions.

These layers (cathode, anode, separator/electrolyte layers) can be sandwiched, rolled up, and/or packed into a cavity of a cylinder-shaped casing 904 (e.g., a metal can). The casings/housings can be rigid such as those made from metallic or hard-plastic, for example. In some embodiments, a separator layer (and/or electrolyte layer) 902 can be arranged between an anode layer 901 and a cathode layer 903 to separate the anode layer 902 and the cathode layer 903. In some embodiments, the layers in the battery cell can alternate such that a separator layer (and/or electrolyte layer) separates an anode layer from a cathode layer. In other words, the layers of the battery electrode can be (in order) separator layer, anode/cathode layer, separator layer, opposite of other anode/cathode layer and so on. The separator layer (and/or electrolyte layer) 902 can prevent contact between the anode and cathode layers while facilitating ion (e.g., lithium ions) transport in the cell. The battery cell can also include at least one terminal 905. The at least one terminal can be electrical contacts used to connect a load or charger to a battery cell. For example, the terminal can be made of an electrically conductive material to carry electrical current from the battery cell to an electrical load, such as a component or system of an electric vehicle as discussed further herein.

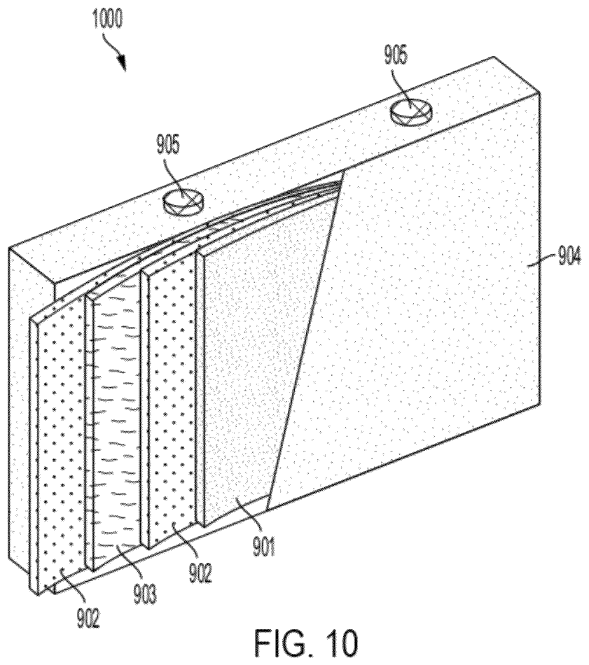

FIG. 10 depicts an illustrative example of a cross sectional view of a prismatic battery cell 1000. The prismatic battery cell can include layers (e.g., sheet-like layers) of anode layers 901, separator and/or electrolyte layers 902, and cathode layers 903. Similar to the cylindrical battery cell, the layers of a prismatic battery cell can be sandwiched, rolled, and/or pressed to fit into cubic or rectangular cuboid (e.g., hyperrectangle) shaped casing/housing 904. In some embodiments, the layers can be assembled by layer stacking rather than jelly rolling. In some embodiments, the casing or housing can be rigid such as those made from a metal and/or hard-plastic. In some embodiments, the prismatic battery cell 1000 can include more than one terminal 905. In some embodiments, one of these terminals can be the positive terminal and the other a negative terminal. These terminals can be used to connect a load or charger to the battery cell.

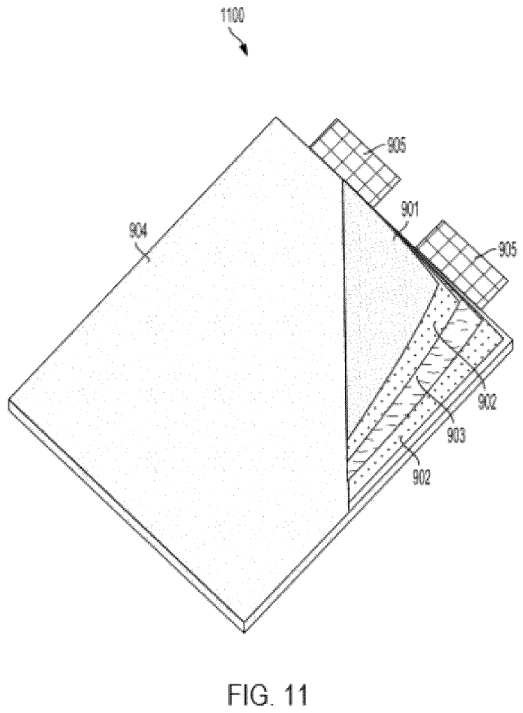

FIG. 11 depicts an illustrative example of a cross section view of a pouch battery cell 1100. The pouch battery cells do not have a rigid enclosure and instead use a flexible material for the casing/housing 904. This flexible material can be, for example, a sealed flexible foil. The pouch battery cell can include layers (e.g., sheet-like layers) of anode layers 901, separator and/or electrolyte layers 902, and cathode layers 903. In some embodiments, these layers are stacked in the casing/housing. In some embodiments, the pouch battery cell 1100 can include more than one terminal 905. In some embodiments, one of these terminals can be the positive terminal and the other the negative terminal. These terminals can be used to connect a load or charger to the battery cell.

The casings/housings of battery cells can include one or more materials with various electrical conductivity or thermal conductivity, or a combination thereof. In some embodiments, the electrically conductive and thermally conductive material for the casing/housing of the battery cell can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. In some embodiments, the electrically conductive and thermally conductive material for the housing of the battery cell can include a ceramic material (e.g., silicon nitride, silicon carbide, titanium carbide, zirconium dioxide, beryllium oxide, and among others) and/or a thermoplastic material (e.g., polyethylene, polypropylene, polystyrene, polyvinyl chloride, or nylon), among others.

At step 804, the battery cell can be finalized. In some embodiments, this step includes the formation process wherein the first charging and discharging process for the battery cell takes place. In some embodiments, this initial charge and discharge can form a solid electrolyte interface between the electrolyte and the electrodes. In some embodiments, this step may cause some of the cells to produce gas which can be removed in a degassing process from the battery cell. In some embodiments, this step includes aging the battery cell. Aging can include monitoring cell characteristics and performance over a fixed period of time. In some embodiments, this step can also include testing the cells in an end-of-line (EOL) test rig. The EOL testing can include discharging the battery cells to the shipping state of charge, pulse testing, testing internal resistance measurements, testing OCV, testing for leakage, and/or optically inspecting the battery cells for deficiencies.

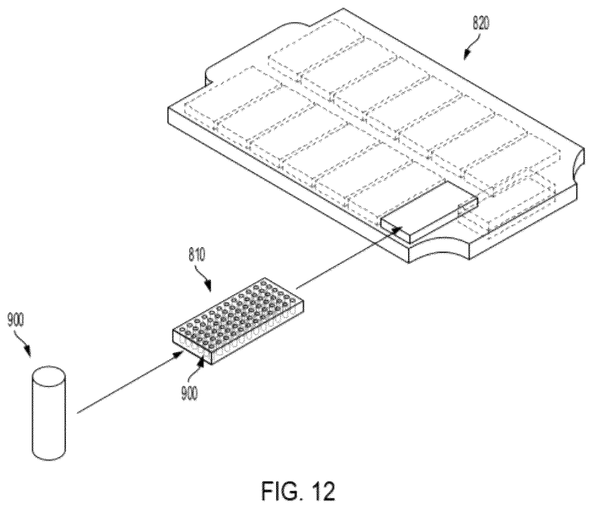

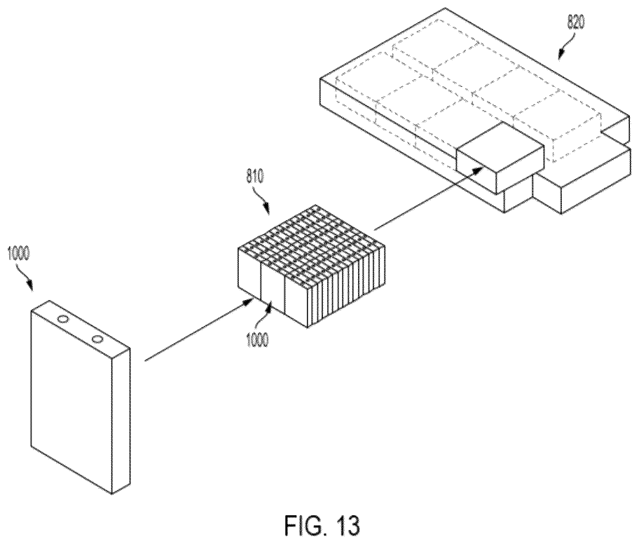

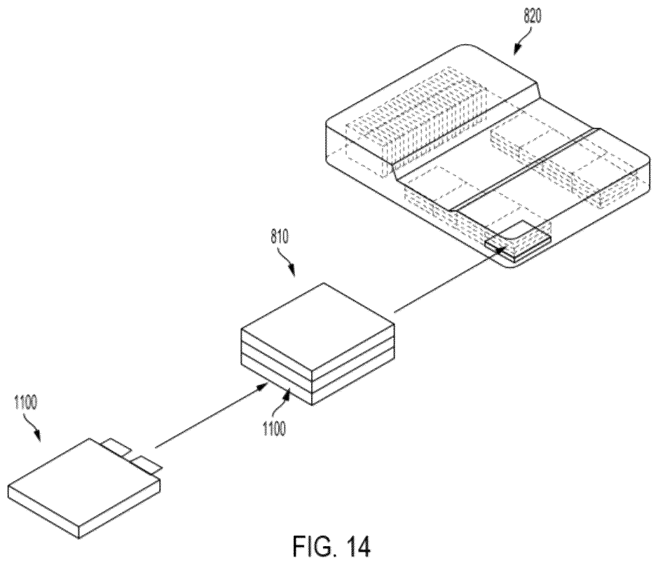

A plurality of battery cells (900, 1000, and/or 1100) can be assembled or packaged together in the same housing, frame, or casing to form a battery module and/or battery pack. The battery cells of a battery module can be electrically connected to generate an amount of electrical energy. These multiple battery cells can be linked to the outside of the housing, frame, or casing, through a uniform boundary. The battery cells of the battery module can be in parallel, in series, or in a series-parallel combination of battery cells. The housing, frame, or casing can protect the battery cells from a variety of dangers (e.g., external elements, heat, vibration, etc.). FIG. 12 illustrates cylindrical battery cells 900 being inserted into a frame to form battery module 810. FIG. 13 illustrates prismatic battery cells 1000 being inserted into a frame to form battery module 810. FIG. 14 illustrates pouch battery cells 1100 being inserted into a frame to form battery module 810. In some embodiments, the battery pack may not include modules. For example, the battery pack can have a “module-free” or cell-to-pack configuration wherein battery cells are arranged directly into a battery pack without assembly into a module.

A plurality of the battery modules 810 can be disposed within another housing, frame, or casing to form a battery pack 820 as shown in FIGS. 12-14. In some embodiments, a plurality of battery cells can be assembled, packed, or disposed within a housing, frame, or casing to form a battery pack (not shown). In such embodiments, the battery pack may not include a battery module (e.g., module-free). For example, the battery pack can have a module-free or cell-to-pack configuration where the battery cells can be arranged directly into a battery pack without assembly into a battery module. In some embodiments, the battery cells of the battery pack can be electrically connected to generate an amount of electrical energy to be provided to another system (e.g., an electric vehicle).

The battery modules of a battery pack can be electrically connected to generate an amount of electrical energy to be provided to another system (e.g., an electric vehicle). The battery pack can also include various control and/or protection systems such as a heat exchanger system (e.g., a cooling system) configured to regulate the temperature of the battery pack (and the individual modules and battery cells) and a battery management system configured to control the battery pack's voltage, for example. In some embodiments, a battery pack housing, frame, or casing can include a shield on the bottom or underneath the battery modules to protect the battery modules from external elements. In some embodiments, a battery pack can include at least one heat exchanger (e.g., a cooling line configured to distribute fluid through the battery pack or a cold plate as part of a thermal/temperature control or heat exchange).

In some embodiments, battery modules can collect current or electrical power from the individual battery cells that make up the battery modules and can provide the current or electrical power as output from the battery pack. The battery modules can include any number of battery cells and the battery pack can include any number of battery modules. For example, the battery pack can have one, two, three, four, five, six, seven, eight, nine, ten, eleven, twelve or other number of battery modules disposed in the housing/frame/casing. In some embodiments, a battery module can include multiple submodules. In some embodiments, these submodules may be separated by a heat exchanger configured to regulate or control the temperature of the individual battery module. For example, a battery module can include a top battery submodule and a bottom battery submodule. These submodules can be separated by a heat exchanger such as a cold plate in between the top and bottom battery submodules.

The battery packs can come in all shapes and sizes. For example, FIGS. 12-14 illustrates three differently shaped battery packs 820. As shown in FIGS. 12-14, the battery packs 820 can include or define a plurality of areas, slots, holders, containers, etc. for positioning of the battery modules. The battery modules can come in all shapes and sizes. For example, the battery modules can be square, rectangular, circular, triangular, symmetrical, or asymmetrical. In some examples, battery modules in a single battery pack may be shaped differently. Similarly, the battery module can include or define a plurality of areas, slots, holders, containers, etc. for the plurality of battery cells.

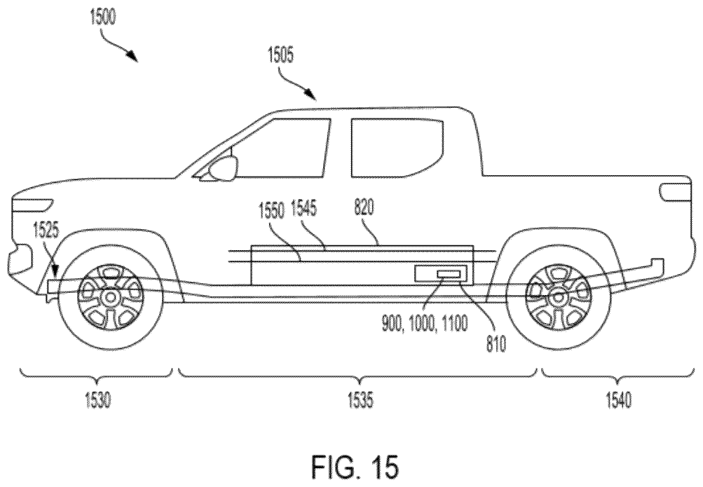

FIG. 15 illustrates an example of a cross sectional view 1500 of an electric vehicle 1505 that includes at least one battery pack 820. Electric vehicles can include, but are not limited to, electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles can be fully electric or partially electric (e.g., plug-in hybrid) and further, electric vehicles can be fully autonomous, partially autonomous, or unmanned. In addition, electric vehicles can also be human operated or non-autonomous.

Electric vehicles 1505 can be installed with a battery pack 820 that includes battery modules 810 with battery cells (900, 1000, and/or 1100) to power the electric vehicles. The electric vehicle 1505 can include a chassis 1525 (e.g., a frame, internal frame, or support structure). The chassis 1525 can support various components of the electric vehicle 1505. In some embodiments, the chassis 1525 can span a front portion 1530 (e.g., a hood or bonnet portion), a body portion 1535, and a rear portion 1540 (e.g., a trunk, payload, or boot portion) of the electric vehicle 1505. The battery pack 820 can be installed or placed within the electric vehicle 1505. For example, the battery pack 820 can be installed on the chassis 1525 of the electric vehicle 1505 within one or more of the front portion 1530, the body portion 1535, or the rear portion 1540. In some embodiments, the battery pack 820 can include or connect with at least one busbar, e.g., a current collector element. For example, the first busbar 1545 and the second busbar 1550 can include electrically conductive material to connect or otherwise electrically couple the battery pack 820 (and/or battery modules 810 or the battery cells 900, 1000, and/or 1100) with other electrical components of the electric vehicle 1505 to provide electrical power to various systems or components of the electric vehicle 1505. In some embodiments, battery pack 820 can also be used as an energy storage system to power a building, such as a residential home or commercial building instead of or in addition to an electric vehicle.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A separator for a battery cell comprising:
a polymer layer having a laser-patterned surface; and
a ceramic layer.

2. The separator of claim 1, wherein the polymer layer comprises: a fluoropolymer, polyvinylidene fluoride, poly(methyl methacrylate), polyvinylidene fluoride-hexafluoropropene copolymer, or a combination thereof.

3. The separator of claim 1, wherein the ceramic layer comprises alumina.

4. The separator of claim 1, wherein the polymer layer overlies the ceramic layer and only partially coats the ceramic layer.

5. The separator of claim 1, comprising a base layer.

6. The separator of claim 5, wherein the ceramic layer overlies the base layer.

7. The separator of claim 1, wherein a pattern of the laser-patterned surface of the separator is formed only on the polymer layer.

8. The separator of claim 1, wherein a pattern of the laser-patterned surface of the separator is not formed on the base layer or the ceramic layer.

9. The separator of claim 1, wherein the laser-patterned surface is formed using a pulse laser.

10. The separator of claim 1, wherein a pattern of the laser-patterned surface comprises a plurality of parallel lines.

11. The separator of claim 10, wherein a depth of each parallel line of the plurality of parallel lines is 2-3 μm.

12. The separator of claim 10, wherein a width of each parallel line of the plurality of parallel lines is 5 μm to 0.2 mm.

13. The separator of claim 1, wherein a pattern of the laser-patterned surface comprises a plurality of dots.

14. The separator of claim 13, wherein each dot of the plurality of dots has a radius of 5 μm to 0.2 mm.

15. The separator of claim 13, wherein each dot of the plurality of dots has a depth of each parallel line of the plurality of parallel lines is 2-3 μm.

16. The separator of claim 1, wherein a pattern of the laser-patterned surface comprises a spiral pattern.

17. The separator of claim 16, wherein the spiral pattern comprises a spiral line having a width of 5 μm to 0.2 mm.

18. The separator of claim 16, wherein the spiral pattern comprises a spiral line having a depth of 2-3 μm.

19. A rechargeable lithium-ion battery comprising:
a separator for a battery cell comprising:
a polymer layer having a laser-patterned surface; and
a ceramic layer.

20. An electric vehicle system comprising the rechargeable lithium-ion battery of claim 16.
